(19) United States
(12) Patent Application Publication
(10) Pub. No.: US 2011/0228057 A1
(43) Pub. Date: Sep. 22, 2011

(54) Image Processing Apparatus, Image Conversion Method, and Program

(76) Inventor: Seiji KOBAYASHI, Tokyo (JP)

(21) Appl. No.: 13/032,947

(22) Filed: Feb. 23, 2011

(30) Foreign Application Priority Data
Mar. 17, 2010 (JP) P2010-061173

(51) Int. Cl. H04N 13/04

(52) U.S. Cl. 348/51; 348/E13.075

(57) ABSTRACT

Disclosed is an image processing apparatus including: a determining unit that determines, based on parallax of a 3D main image including a left-eye main image and a right-eye main image, parallax of a sub-image overlapped with the 3D main image and determines a zoom-in/out ratio of the sub-image based on parallax of the corresponding sub-image; a magnification/reduction processing unit that magnifies or reduces the sub-image depending on the zoom-in/out ratio; a creating unit that creates a left-eye sub-image and a right-eye sub-image by shifting the sub-image in left and right directions based on the parallax of the sub-image; and a synthesizing unit that synthesizes, for each eye, the left-eye main image and the right-eye main image with the left-eye sub-image and the right-eye sub-image created by magnifying/reducing and shifting the sub-image in left and right directions.

### BACKGROUND OF THE INVENTION

1. Field of the Invention

The present invention relates to an image processing apparatus, an image conversion method, and a program, and particularly, to an image processing apparatus, an image conversion method, and a program capable of allowing a viewer to recognize a sub-image such as a subtitle having the same size at all times without depending on the display position of the depthwise direction of the sub-image when a 3D main image is overlappingly displayed.

2. Description of the Related Art

Recently, as 3D movies using stereoscopic views of both eyes have been popularized, the environment for reproducing 3D contents on consumer electronic appliances is being developed. In this circumstance, a method of displaying sub-images such as a subtitle or a menu screen overlapped with the main image in 3D movies or the like starts to be problematic.

For example, an image processing apparatus for multiplexing a display position in a depthwise direction which is normal to the display surface of the subtitle into the subtitle data and the main image data has been proposed (for example, refer to Japanese Unexamined Patent Application Publication No. 2004-274125).

However, Japanese Unexamined Patent Application Publication No. 2004-274125 fails to describe a method of determining the display position of the subtitle in the depthwise direction and also fails to describe a method of temporally (dynamically) changing the display position of the subtitle in the depthwise direction.

Therefore, in the image processing apparatus according to Japanese Unexamined Patent Application Publication No. 2004-274125, as shown in FIGS. 1A and 1B, when the display position of a 3D main image containing a mountain 11 and a tree 12 in the depthwise direction changes with time, the display position of the subtitle 13 in the depthwise direction may be positioned in front of the main image (in the user side) or at the rear of the main image (in the display surface side) as shown in FIG. 1A.

As shown in FIG. 1A, when the display position of the subtitle 13 in the depthwise direction is in front of the main image, a user focuses a point of view on the front side to see the subtitle 13. In other words, it is necessary to increase the convergence angle. On the other hand, a user focuses a point of view on the rear side to see the main image. In other words, it is necessary to reduce the convergence angle. Therefore, when a difference is large between the distances of the display positions of the subtitle 13 and the main image in the depthwise direction, it is necessary to instantaneously move a point of view to see both the subtitle 13 and the main image simultaneously. Therefore, in this case, the display image becomes very difficult to see and makes the eyes tired.

As shown in FIG. 1B, when the display position of the subtitle 13 in the depthwise direction is at the rear of the main image, and the main image is displayed in front of the subtitle 13, the subtitle 13 is viewed as being buried in the main image. Therefore, the display image looks very unnatural and makes the eyes tired.

In this regards, there has been proposed a system of controlling the display position of the subtitle in the depthwise direction depending on the maximum value of the display position of the main image in the depthwise direction, extracted from or applied to a 3D main image (for example, refer to pamphlet of International Publication WO. 08/115,222). In this document, the value of the display position in the depthwise direction increases in the front side.

In this system, even when the display position of the main image in the depthwise direction changes with time, the display position of the subtitle 13 in the depthwise direction can be located in the nearest side to the main image in front of the main image based on the maximum value of the display position of the main image in the depthwise direction at all times. For example, even when the position of the main image in the depthwise direction changes from the position shown in FIG. 2A to the position shown in FIG. 2B with time, the display position of the subtitle 13 in the depthwise direction can be located in the nearest side to the tree 12 in front of the tree 12 at all times. Therefore, the display image becomes a natural image in which the subtitle 13 is located in front of the main image and also a conspicuous image in which a movement amount of the point of view is small.

However, in the system disclosed in the pamphlet of International Publication WO. 08/115,222, for example, as shown in FIGS. 3A and 3B, when the mountain 11 included in the main image does not change its position with time, but a vehicle 14 moves from the rear side shown in FIG. 3A to the front side shown in FIG. 3B with time, the subtitle 13 also moves from the rear side to the front side. In this case, since the size of the vehicle 14 occupied in a total field of view changes as it moves to the front side, the display size of the vehicle 14 increases, but the display size of the subtitle 13 does not change.

More specifically, as shown in FIG. 4A, if a field of view of the vehicle 14 relative to a total field of view when a vehicle 14 having a horizontal width W1 is observed from the position of the visual range d1 is set to θ1, a field of view of the vehicle 14 relative to the total field of view when the vehicle 14 having the same width W1 is observed from a position of the visual range d2 shorter than the visual range d1 is set to θ2 which is larger than θ1. Therefore, the horizontal width of the vehicle 14 within the display image is larger in the case of FIG. 4B in comparison with the case of FIG. 4A.

However, the display size of the subtitle 13 does not change depending on the display position of the subtitle 13 in the depthwise direction. Therefore, a field of view of the subtitle 13 relative to a total field of view becomes constant regardless of the visual range, and a field of view of the subtitle 13 relative a total field of view when it is observed from the position of the visual range d4 as shown in FIG. 5B becomes θ3 which is the same as a field of view of the subtitle 13 relative to a total field of view when it is observed from the position of the visual range d3 which is longer than the visual range d4 as shown in FIG. 5A. Therefore, when the display position of the subtitle 13 having a horizontal width W3 in the depthwise direction moves to the position of the visual range d4 from the position of the visual range d3, as shown in FIG. 5B, a viewer erroneously feels that the horizontal width of the subtitle 13 changes from the horizontal width W3 to the horizontal width W4 which is smaller than the horizontal width W3. Such a phenomenon is affected by “size consistency” of a sense of vision, and is also known as a visual illusion.

### SUMMARY OF THE INVENTION

In this manner, in the system disclosed in Pamphlet of International Publication WO. 08/115,222, since the display size of the subtitle is constant regardless of the display position of the subtitle in the depthwise direction, a viewer feels that the subtitle is enlarged when the display position of the subtitle in the depthwise direction moves in the rear side. Meanwhile, when the display position of the subtitle in the depthwise direction moves in the front side, a viewer feels that the subtitle is reduced.

It is desirable to allow a viewer to recognize a sub-image such as a subtitle having the same size at all times without depending on the display position of the depthwise direction of the sub-image when a 3D main image is overlappingly displayed.

According to an embodiment of the invention, there is provided an image processing apparatus including: a determining means for determining, based on parallax of a 3D main image including a left-eye main image and a right-eye main image, parallax of a sub-image overlapped with the 3D main image and determines a zoom-in/out ratio of the sub-image based on parallax of the corresponding sub-image; a magnification/reduction processing means for magnifying or reducing the sub-image depending on the zoom-in/out ratio; a creating means for creating a left-eye sub-image and a right-eye sub-image by shifting the sub-image in left and right directions based on the parallax of the sub-image; and a synthesizing means for synthesizing, for each eye, the left-eye main image and the right-eye main image with the left-eye sub-image and the right-eye sub-image created by magnifying/reducing and shifting the sub-image in left and right directions.

An image processing method and a program according to an embodiment of the invention correspond to an image processing apparatus according to an embodiment of the invention.

According to an embodiment of the invention, parallax of a sub-image overlapped with a 3D main image is determined based on parallax of the 3D main image including a left-eye main image and a right-eye main image, and a zoom-in/out ratio of the sub-image is determined based on parallax of the corresponding sub-image. The sub-image is magnified or reduced depending on the zoom-in/out ratio. A left-eye sub-image and a right-eye sub-image are created by shifting the sub-image in left and right directions based on the parallax of the sub-image. The left-eye main image and the right-eye main image are synthesized for each eye with the left-eye sub-image and the right-eye sub-image created by magnifying/reducing and shifting the sub-image in left and right directions.

According to an embodiment of the invention, it is possible to allow a viewer to recognize the sub-image having the same size at all times regardless of the display position of the sub-image in the depthwise direction when the sub-image such as a subtitle is overlappingly displayed with the 3D main image.

### BRIEF DESCRIPTION OF THE DRAWINGS

FIGS. 1A and 1B are diagrams illustrating an example of display positions of the main image and the subtitle in the depthwise direction.

FIGS. 2A and 2B are diagrams illustrating another example of display positions of the main image and the subtitle in the depthwise direction.

FIGS. 3A and 3B are diagrams illustrating a display example of the main image and the subtitle when the display position of the main image in the depthwise direction changes.

FIGS. 4A and 4B are diagrams illustrating change of a field of view caused by change of the visual range.

FIGS. 5A and 5B are diagrams illustrating visual illusion.

FIG. 6 is a block diagram illustrating a configuration example of the image processing apparatus according to an embodiment of the invention.

FIG. 7 is a diagram illustrating a first method of determining parallax of the subtitle image.

FIG. 8 is a diagram illustrating a second method of determining parallax of the subtitle image.

FIG. 9 is a diagram illustrating a third method of determining parallax of the subtitle image.

FIG. 10 is a diagram illustrating an image formation position of a 3D image.

FIG. 11 is a diagram illustrating a relationship between an image formation position of the image and a size of the retinal image of a viewer.

FIG. 12 is a block diagram illustrating a configuration example of the subtitle image creating unit of FIG. 6.

FIG. 13 is a diagram illustrating a first method of producing a subtitle image.

FIG. 14 is a diagram illustrating a second method of producing a subtitle image.

FIG. 15 is a flowchart illustrating an image synthesizing process using an image processing apparatus.

FIG. 16 is a diagram illustrating a configuration example of a computer according to an embodiment of the invention.

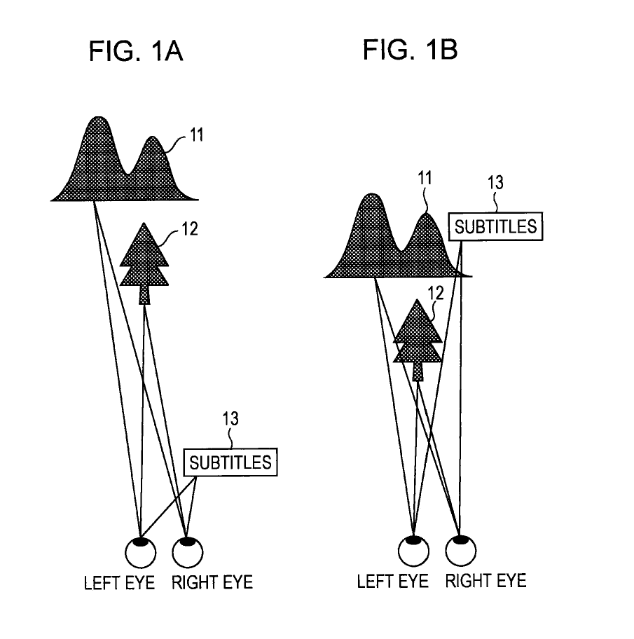

### DESCRIPTION OF THE PREFERRED EMBODIMENTS

### Embodiment

### Configuration Example of Image Processing Apparatus of Embodiment

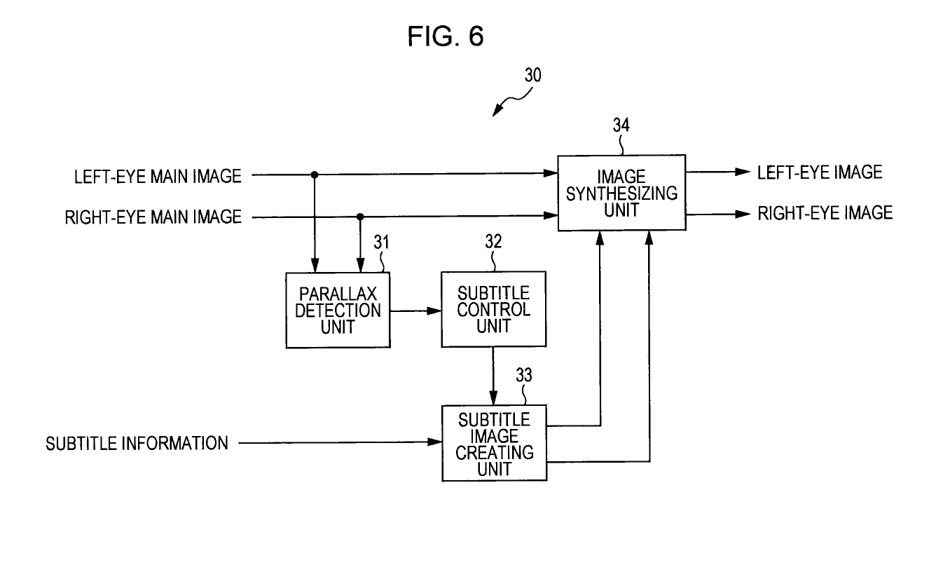

FIG. 6 is a block diagram illustrating a configuration example of the image processing apparatus according to an embodiment of the invention.

The image processing apparatus 30 of FIG. 6 includes a parallax detection unit 31, a subtitle control unit 32, a subtitle image creating unit 33, and an image synthesizing unit 34. The image processing apparatus 30 outputs a 3D main image on an input screen basis by overlapping a subtitle image which is an image representing the subtitle on a screen basis.

Specifically, the parallax detection unit 31 of the image processing apparatus 30 receives a 3D main image including the left-eye main image and the right-eye main image on a screen basis from an external side. The parallax detection unit 31 detects the number of pixels representing a difference (parallax) between the display positions of the received left-eye main image and the received right-eye main image in a horizontal direction (left-right direction) as parallax for each predetermined unit (for example, pixel or block including a plurality of pixels).

In addition, when the display position of the left-eye main image in the horizontal direction is in the right side of the display position of the right-eye main image in the horizontal direction, the parallax is represented as a positive value. Otherwise, when the display position of the left-eye main image is in the left side of the display position of the right-eye main image in the horizontal direction, the parallax is represented as a negative value. In other words, if the parallax has a positive value, the display position of the main image in the depthwise direction is in front of the display surface. Otherwise, if the parallax has a negative value, the display position of the main image in the depthwise direction is at the rear of the display surface.

In addition, the parallax detection unit 31 supplies the subtitle control unit 32 with parallax information representing parallax of the entire screen of the 3D main image based on the detected parallax. The parallax information may include a maximum value and a minimum value of the parallax of the entire screen of the 3D main image, a histogram of parallax of the entire screen, a parallax map representing parallax in each position on the entire screen, or the like.

The subtitle control unit 32 (determining means) determines parallax of the subtitle image created by the subtitle image creating unit 33 based on the parallax information supplied from the parallax detection unit 31. In addition, the subtitle control unit 32 determines the zoom-in/out ratio of the subtitle image based on the parallax of the subtitle image. The subtitle control unit 32 supplies the subtitle image creating unit 33 with the determined parallax and the determined zoom-in/out ratio as subtitle control information.

The subtitle image creating unit 33 receives the subtitle information as information for displaying the subtitle for a single screen from an external side. In addition, the subtitle information includes, for example, text information including font information of the character string of the subtitle for a single screen and arrangement information representing the position of the subtitle for a single screen on the screen. The subtitle image creating unit 33 creates the subtitle image having the same resolution as that of the main image based on the received subtitle information.

The subtitle image creating unit 33 2-dimensionally enlarges or reduces the size of the subtitle image based on the zoom-in/out ratio out of the subtitle control information supplied from the subtitle control unit 32. In addition, the subtitle image creating unit 33 creates a left-eye subtitle image and a right-eye subtitle image by shifting the subtitle image in a left-right direction based on the parallax out of the subtitle control information supplied from the subtitle control unit 32. In addition, the subtitle image creating unit 33 supplies the image synthesizing unit 34 with the left-eye subtitle image and the right-eye subtitle image.

The image synthesizing unit 34 synthesizes, for each eye, the left-eye main image and the right-eye main image that have been received from an external side with the left-eye subtitle image and the right-eye subtitle image supplied from the subtitle image creating unit 33. The image synthesizing unit 34 outputs the left-eye image and the right-eye image resulting from the synthesizing.

Although the image processing apparatus 30 of FIG. 6 detects the parallax using the parallax detection unit 31, the parallax may be detected externally and the parallax information may be input to the image processing apparatus 30. In this case, the image processing apparatus 30 is not provided with the parallax detection unit 31.

Description of Method of Determining Parallax of Subtitle Image

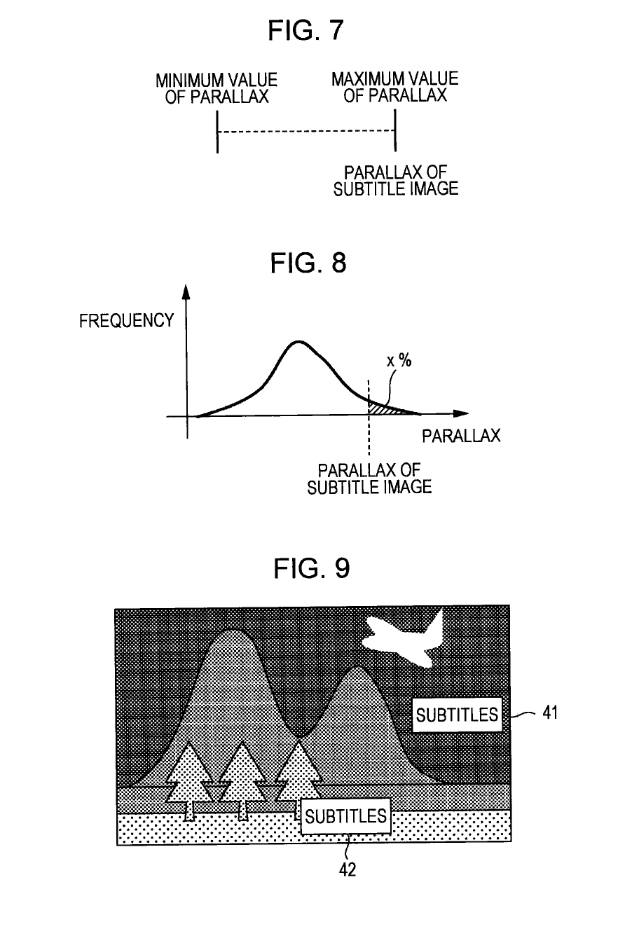

FIGS. 7 to 9 are diagrams illustrating a method of determining parallax of the subtitle image using the subtitle control unit 32.

Referring to FIG. 7, when the minimum value of parallax and the maximum value of parallax are supplied from the parallax detection unit 31 as the parallax information, the subtitle control unit 32 determines, for example, the maximum value of parallax as the parallax of the subtitle image. As a result, the display position of the subtitle image in the depthwise direction becomes the same position as that of the main image in the most front side.

Referring to FIG. 8, when the histogram of parallax is supplied from the parallax detection unit 31 as the parallax information, the subtitle control unit 32 determines, as the parallax of the subtitle, for example, the parallax at which the area resulting from the maximum value (the hatching area in FIG. 8) occupies x% of the entire area in the histogram.

Referring to FIG. 9, when a parallax map is supplied from the parallax detection unit 31 as the parallax information, the subtitle control unit 32 determines, as the parallax of the subtitle image, the maximum value of parallax of the main image in the position of the subtitle image on the screen based on, for example, the arrangement information included in the subtitle information.

Specifically, as shown in FIG. 9, the parallax of the subtitle 41 arranged in the right end on the screen is determined as the maximum value of parallax in the right end of the main image, and the parallax of the subtitle 42 arranged in the lower center on the screen is determined as the maximum value of parallax in the lower center of the main image. In addition, the magnitude of the density in the parallax map of FIG. 9 represents that the parallax is low. In other words, the parallax of the bright portion having a low density in the drawing is high, and that portion is displayed in the front side. On the contrary, the parallax of the dark portion having a high density in the drawing is low, and that portion is displayed in the rear side. Therefore, in FIG. 9, the parallax at the right end of the main image is lower than the parallax in the lower center, and the subtitle 41 is displayed at the rear of the subtitle 42.

When a plurality of subtitles reside in a single screen, the subtitle control unit 32 determines the parallax for each subtitle based on the parallax map and the arrangement information of each subtitle included in the subtitle information and supplies the subtitle image creating unit 33 with the parallax of all subtitles as the parallax of the subtitle image. In this case, the zoom-in/out ratio is also determined for each subtitle based on the parallax of each subtitle, and the zoom-in/out ratios of all subtitles are output as the zoom-in/out ratio of the subtitle image.

In addition, the method of determining the parallax of the subtitle image is not limited to those described in conjunction with FIGS. 7 and 9, but may include any method if it can be displayed in a position easily recognizable by a viewer when the subtitle image is overlapped with the 3D main image.

Description of Method of Determining Zoom-in/Out Ratio

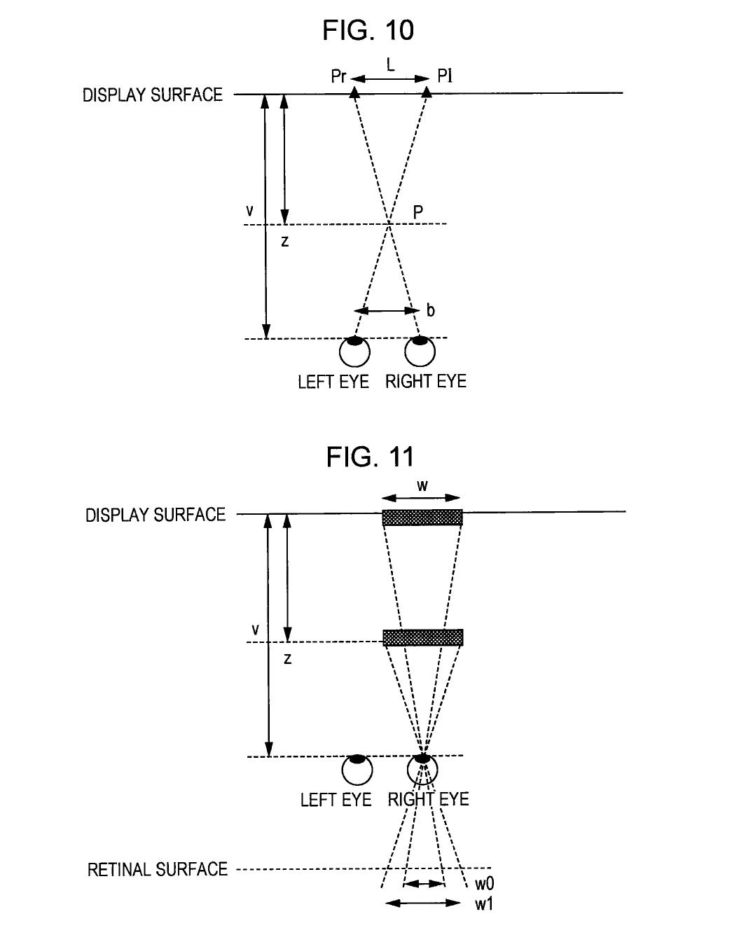

FIGS. 10 and 11 are diagrams illustrating a method of determining the zoom-in/out ratio using the subtitle control unit 32.

FIG. 10 is a diagram illustrating an image formation position of the 3D image including the left-eye image Pr and the right-eye image Pl.

In FIG. 10, a differential distance L of the display position in the horizontal direction between the left-eye image Pr and the right-eye image Pl is expressed as the following equation (1).

L=d×p (1)

In the equation (1), the reference numeral d denotes the parallax (number of pixels) of a 3D image including the left-eye image Pr and the right-eye image Pl, and the reference numeral p denotes the size of the pixel of a 3D image display apparatus in a horizontal direction.

In addition, when a viewer watches the 3D image including the left-eye image Pr and the right-eye image Pl through both eyes on a baseline (interocular distance) b from the position of the visual range v, the position P where the left-eye image Pr and the right-eye image Pl are formed is in front of the display surface by a distance z. In addition, a relationship between the distance L, the baseline b, the visual range v, and the distance z can be expressed as the following equation (2).

$$\frac{L}{b} = \frac{z}{v - z} \qquad ( 2 )$$

By modifying the equation (2), the distance z can be expressed as the following equation (3).

$$z = \frac{v}{\frac{b}{L} + 1} \qquad ( 3 )$$

In addition, FIG. 11 is a diagram illustrating a relationship between the position of forming the image having a width w and the size of the retinal image of a viewer.

As shown in FIG. 11, when an image having width w is formed on the display surface, the width of the image projected to the retinas of a viewer who watches the image at the position of a visual range v is set to w0. Meanwhile, when an image having a width w is formed in front of the display surface by a distance z, the width of the image projected to the retinas of a viewer who watches the image at the position of a visual range v is set to a width w1. Originally, although the retinal surface is included in an eyeball and is curved, for the purpose of simplified description, herein, it is assumed that the retinal surface is a plane located at the rear of eyes. In this case, a relationship between the widths w0 and w1 can be expressed as the following equation (4).

$$\frac{w 0}{w 1} = 1 - \frac{z}{v} \qquad ( 4 )$$

In this case, as described in conjunction with FIG. 10, the 3D image of a distance L is formed in front of the display surface by a distance z. Therefore, in order to project the 3D image located in front of the display surface by a distance z as an image having width w1 as a retinal image of a viewer, it is necessary to display the 3D image having a distance L and a width w by magnifying or reducing it using the zoom-in/out ratio S expressed in the following equation (5).

$$S = \frac{w 1}{w 0} = 1 + \frac{L}{b} \qquad ( 5 )$$

According to the equation (5), the zoom-in/out ratio S only depends on the distance L and the baseline b, but does not depend on the visual range v. Here, the baseline b may be fixed to a standard value (about 65 mm) of the baselines for adult persons. When the baseline b is a fixed value, the zoom-in/out ratio S is uniquely determined based on the distance L.

In addition, as shown in the equation (1), since the distance L is determined based on the parallax d and the size p of the pixel of the display device, if the size p of the pixel of the display device is of the related art, it is possible to obtain the distance L from the parallax d.

Therefore, the subtitle control unit 32 calculates the distance L based on the equation (1) using the size pP of the pixel of the display device of the related art and the parallax d of the subtitle image and obtains the zoom-in/out ratio S based on the equation (5) using the baseline b established in advance and the calculated distance L.

As a result, when the display position of the subtitle image in the depthwise direction is the position of the display surface, the distance L becomes zero. Therefore, the zoom-in/out ratio S becomes 1. In addition, when the display position of the subtitle image in the depthwise direction is at the rear of the display surface, the distance L has a negative value. Therefore, the zoom-in/out ratio S becomes smaller than 1. In other words, when the display position of the subtitle image in the depthwise direction is at the rear of the display surface, the subtitle image is reduced. On the contrary, when the display position of the subtitle image in the depthwise direction is in front of the display surface, the distance L has a positive value. Therefore, the zoom-in/out ratio S has a value larger than 1. In other words, when the display position of the subtitle image in the depthwise direction is at the rear of the display surface, the subtitle image is magnified.

Since the subtitle image is magnified or reduced in this manner, regardless of whether the display position of the subtitle image in the depthwise direction is in front or at the rear of the display surface, the width of the subtitle image projected to the retinal image becomes the same as when the original subtitle image is displayed in that display position in the depthwise direction at all times. Therefore, even when the display position of the subtitle image in the depthwise direction moves, a viewer can recognize that the size of the subtitle image is the same.

In addition, the baseline b may be established in advance, or may be established by a user. In addition, the size p of the pixel may be established by a user, or may be transmitted from a display device.

Configuration Example of Subtitle Image Creating Unit

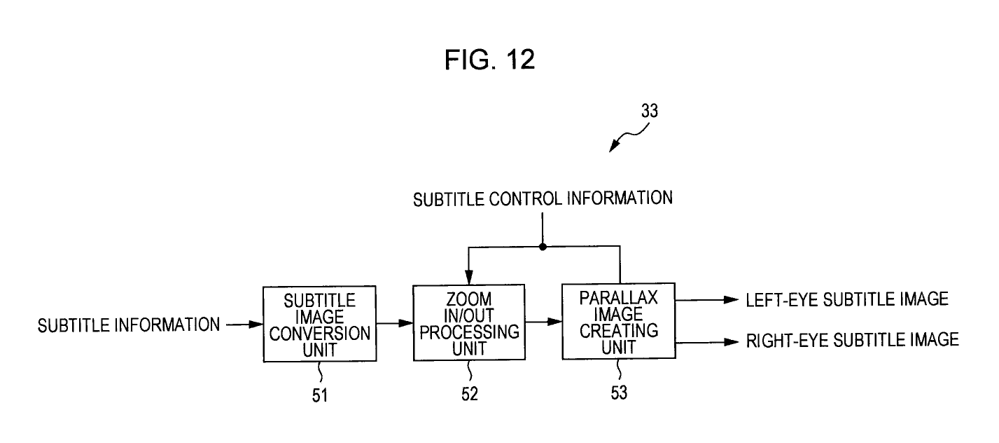

FIG. 12 is a block diagram illustrating a configuration example of the subtitle image creating unit 33 of FIG. 6.

Referring to FIG. 12, the subtitle image creating unit 33 includes a subtitle image conversion unit 51, a zoom-in/out processing unit 52, and a parallax image creating unit 53.

The subtitle image conversion unit 51 of the subtitle image creating unit 33 creates the subtitle image having the same resolution as that of the main image and supplies it to the zoom-in/out processing unit 52 based on the resolution of the main image established in advance and the received subtitle information.

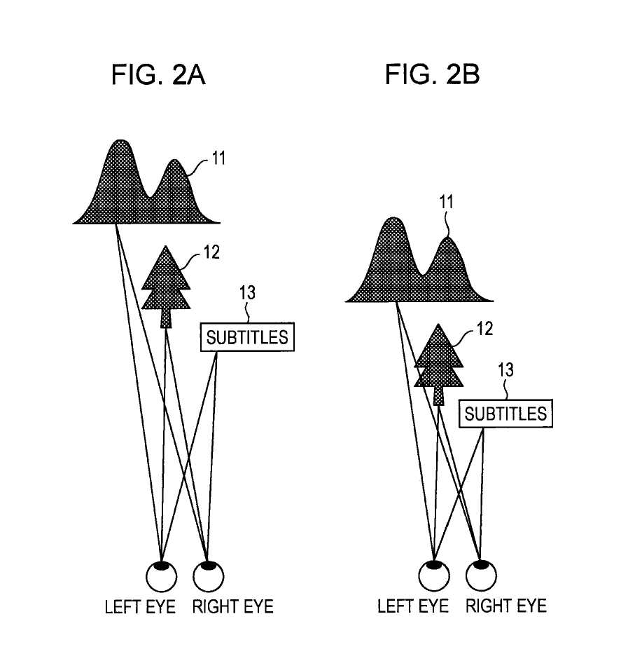

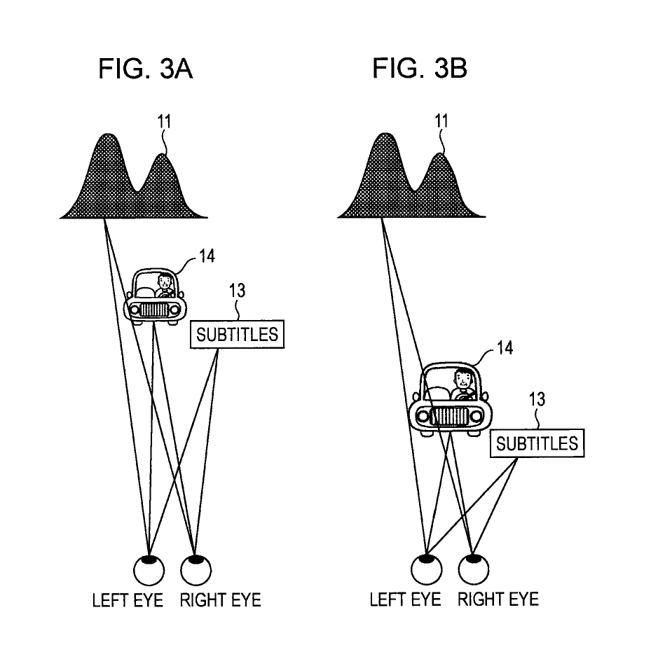

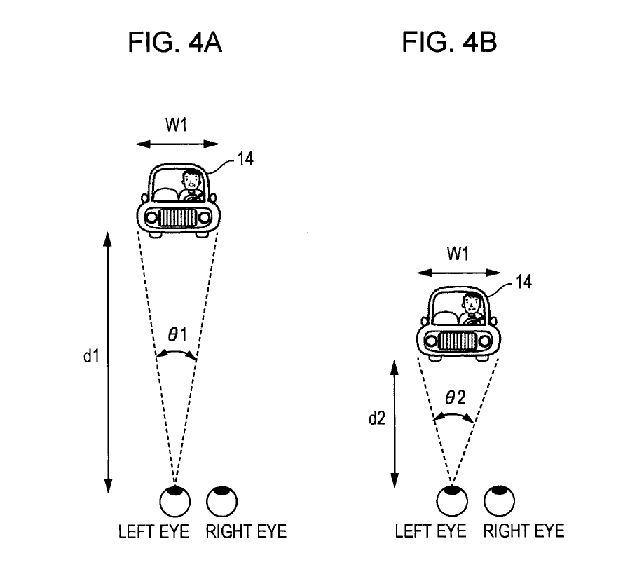

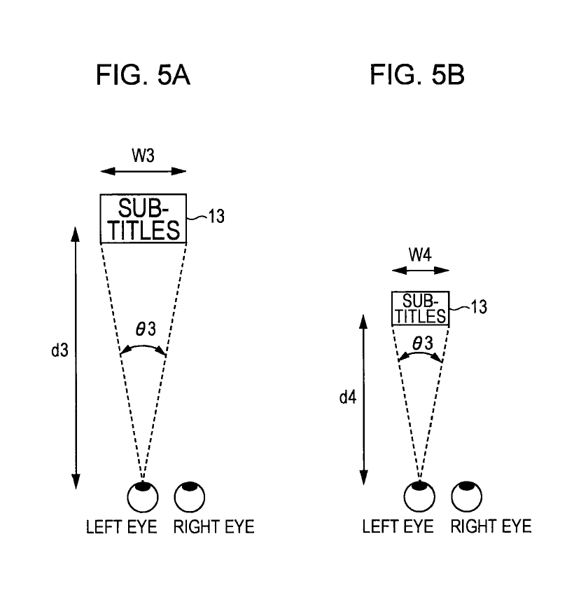

The zoom-in/out processing unit 52 carries out a digital filtering process for the subtitle image supplied from the subtitle image conversion unit 51 based on the zoom-in/out ratio included in the subtitle control information supplied from the subtitle control unit 32 of FIG. 6 to 2-dimensionally magnify or reduce the subtitle image. In addition, when the zoom-in/out ratios for a plurality of subtitles are supplied from the subtitle control unit 32, the zoom-in/out processing unit 52 2-dimensionally magnifies or reduces each of the subtitles within the subtitle image based on the zoom-in/out ratio of that subtitle. The zoom-in/out processing unit 52 supplies the magnified or reduced subtitle image to the parallax image creating unit 53.

The parallax image creating unit 53 creates the left-eye subtitle image and the right-eye subtitle image by shifting the subtitle image supplied from the zoom-in/out processing unit 52 in the left or right direction based on the parallax included in the subtitle control information supplied from the subtitle control unit 32 of FIG. 6.

Specifically, the parallax image creating unit 53 creates the left-eye subtitle image and the right-eye subtitle image by shifting the subtitle image by a half of the parallax in the left and right directions. In addition, the parallax image creating unit 53 outputs the left-eye subtitle image and the right-eye subtitle image to the image synthesizing unit 34 (FIG. 6).

In addition, the parallax image creating unit 53 may create the left-eye subtitle image and the right-eye subtitle image by shifting the subtitle image in a one-way direction rather than in both left and right directions. In this case, the parallax image creating unit 53 creates one of the left-eye subtitle image and the right-eye subtitle image by shifting the subtitle image by the parallax in any one of the left and right directions and establishes the original subtitle image before the shifting as the other one.

In addition, when the parallax included in the subtitle control information is an integer, the parallax image creating unit 53 carries out the shifting of the subtitle image using simple pixel shifting. On the contrary, when the parallax is a real number, the parallax image creating unit 53 carries out the shifting of the subtitle image using interpolation through a digital filtering process.

Furthermore, when parallax of a plurality of subtitles is supplied from the subtitle control unit 32, the parallax image creating unit 53 creates the left-eye subtitle image and the right-eye subtitle image by shifting each subtitle within the subtitle image into left and right directions based on the parallax of the corresponding subtitle.

Description of Method of Creating Subtitle Image

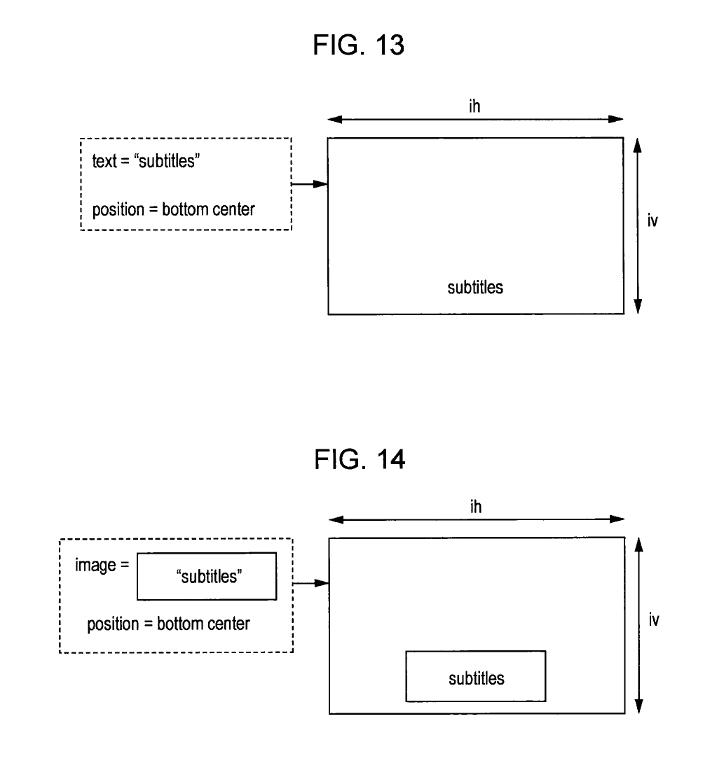

FIG. 13 is a diagram illustrating a method of creating the subtitle image when the subtitle information includes text information and arrangement information.

Referring to FIG. 13, when the subtitle information includes text information and arrangement information, the subtitle image conversion unit 51 creates the subtitle based on the text information, and creates the subtitle image by arranging the subtitle at the position represented by the arrangement information. In the example of FIG. 13, the text information (text) includes font information of the character string denoted by “subtitles” and arrangement information (position) represents the bottom center. Therefore, a subtitle image in which the subtitle including the characters “subtitles” is arranged in the bottom center of the screen is created. In addition, the number of pixels of the subtitle image in the horizontal direction is set to a value ih which is equal to the number of pixels of the main image in the horizontal direction, and the number of pixels in the vertical direction is set to a value iv which is equal to the number of pixels of the main image in the vertical direction. In other words, the resolution of the subtitle image is equal to the resolution of the main image.

FIG. 14 is a diagram illustrating a method of creating the subtitle image when the subtitle information includes the subtitle and the arrangement information.

Referring to FIG. 14, when the subtitle information includes the subtitle and the arrangement information, the subtitle image conversion unit 51 creates the subtitle information by arranging the subtitle in the position represented by the arrangement information. In the example of FIG. 14, the subtitle (image) is an image of characters denoted by “subtitles,” and the arrangement information (position) represents the bottom center. As a result, a subtitle image is created such that an image including characters “subtitles” is arranged in the bottom center on the screen. In addition, in the case of FIG. 14, similar to the case of FIG. 13, the number of pixels of the subtitle image in the horizontal direction is set to a value ih which is equal to the number of pixels of the main image in the horizontal direction, and the number of pixels in the vertical direction is set to a value iv which is equal to the number of pixels of the main image in the vertical direction.

Description of Processing in Image Processing Apparatus

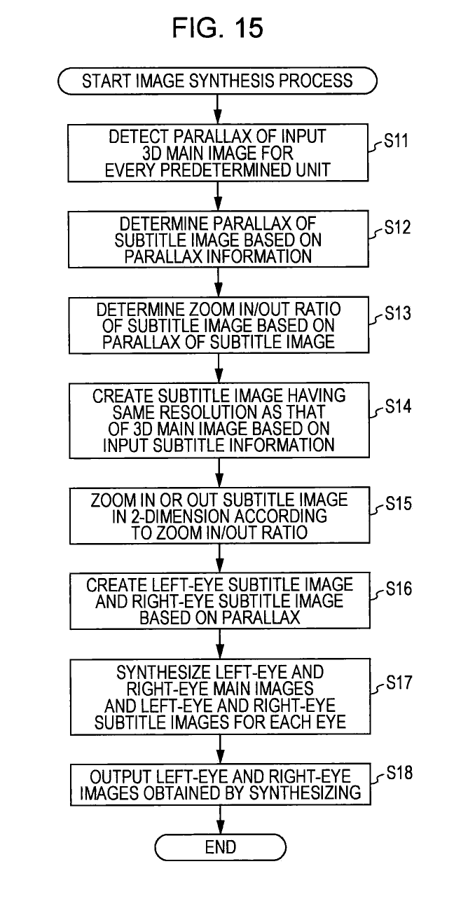

FIG. 15 is a flowchart illustrating an image synthesizing process using the image processing apparatus 30. The image synthesizing process is initiated, for example, when the 3D main image and the subtitle information are input to the image processing apparatus 30.

In step S11, the parallax detection unit 31 (FIG. 6) of the image processing apparatus 30 detects the parallax of the 3D main image input from an external side for each predetermined unit. The parallax detection unit 31 supplies the subtitle control unit 32 with the parallax information based on the detected parallax.

In step S12, the subtitle control unit 32 determines the parallax of the subtitle image created by the subtitle image creating unit 33 based on the parallax information supplied from the parallax detection unit 31.

In step S13, the subtitle control unit 32 determines the zoom-in/out ratio of the subtitle image based on the parallax of the subtitle image determined in step S11. The subtitle control unit 32 supplies the subtitle image creating unit 33 with the determined parallax and the zoom-in/out ratio as the subtitle control information.

In step S14, the subtitle image conversion unit 51 (FIG. 12) of the subtitle image creating unit 33 creates the subtitle image having the same resolution as that of the 3D main image based on the received subtitle information and supplies it to the zoom-in/out processing unit 52.

In step S15, the zoom-in/out processing unit 52 2-dimensionally magnifies or reduces the subtitle image supplied from the subtitle image conversion unit 51 based on the zoom-in/out ratio included in the subtitle control information supplied from the subtitle control unit 32 of FIG. 6. The zoom-in/out processing unit 52 supplies the parallax image creating unit 53 with the magnified or reduced subtitle image.

In step S16, the parallax image creating unit 53 creates the left-eye subtitle image and the right-eye subtitle image by shifting the subtitle image supplied from the zoom-in/out processing unit 52 in the left and right directions based on the parallax included in the subtitle control information supplied from the subtitle control unit 32 of FIG. 6. In addition, the parallax image creating unit 53 outputs the left-eye subtitle image and the right-eye subtitle image to the image synthesizing unit 34 (FIG. 6).

In step S17, the image synthesizing unit 34 synthesizes, for each eye, the left-eye main image and the right-eye main image received from an external side with the left-eye subtitle image and the right-eye subtitle image supplied from the parallax image creating unit 53.

In step S18, the image synthesizing unit 34 outputs the left-eye image and the right-eye image resulting from the synthesis and terminates the process.

As described above, the image processing apparatus 30 determines the parallax of the subtitle image based on the parallax information of the 3D main image and creates the left-eye subtitle image and the right-eye subtitle image based on the corresponding parallax. Therefore, it is possible to display the subtitle in an optimal position relative to the 3D main image in the depthwise direction.

In addition, the image processing apparatus 30 determines the zoom-in/out ratio of the subtitle image based on the parallax of the subtitle image and magnifies or reduces the subtitle image based on the corresponding zoom-in/out ratio. Therefore, it is possible to allow a viewer to recognize the subtitle having the same size at all times regardless of the display position of the subtitle in the depthwise direction. As a result, the image processing apparatus 30 can display the subtitle without making a viewer tired when viewing.

In addition, although the subtitle is overlapped with the 3D main image in the aforementioned description, the image overlapped with the 3D main image may include a sub-image such as a logo or a menu image other than the subtitle.

In addition, the subtitle information and the 3D main image input to the image processing apparatus 30 may be reproduced from a predetermined recording medium or transmitted via networks or broadcast waves.

Description of Computer of Present Invention

Next, a series of processes described above may be carried out using hardware or software. When a series of processes are carried out using software, a program included in the corresponding software is installed in a general-purpose computer or the like.

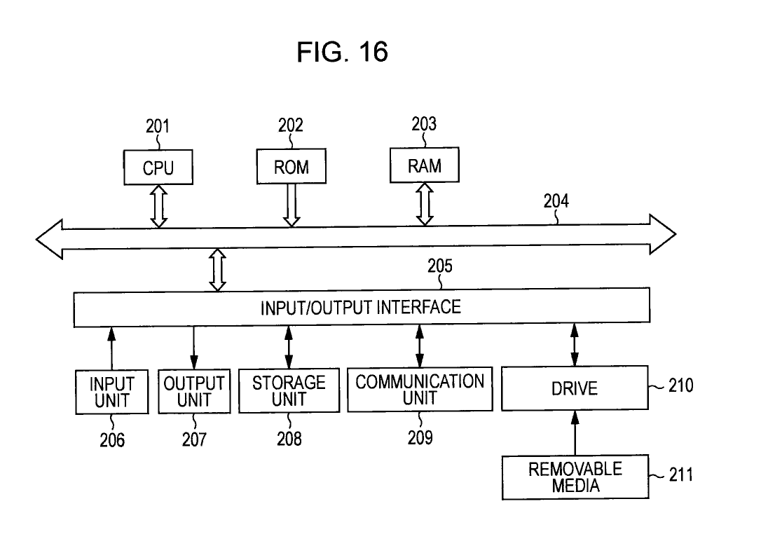

In this regard, FIG. 16 illustrates a configuration example of a computer where a program for executing a series of processes described above is installed according to an embodiment of the invention.

The program may be recorded in advance in a storage unit 208 or a read-only memory (ROM) 202 as a recording medium integrated in the computer.

Alternatively, the program may be stored (recorded) in removable media 211. Such removable media 211 may be provided as so-called package software. In this case, the remote media 211 may include a flexible disk, a compact disc read only memory (CD-ROM), a magnetic optical (MO) disk, a digital versatile disc (DVD), a magnetic disk, a semiconductor memory, or the like.

In addition, the program may be installed in an internal storage unit 208 by downloading to a computer via a communication network or a broadcast network in addition to installation from the remote media 211 to the computer through a drive 210 described above. In other words, the program may be transmitted wirelessly, for example, from a download site to the computer via an artificial satellite for digital satellite broadcasting or may be transmitted to the computer through a cable via networks such as a local area network (LAN) or the Internet.

The computer is internally provided with a central processing unit (CPU) 201), and the CPU 201 is connected to the input/output interface 205 through a bus 204.

The CPU 201, when an instruction is input from a user through the input/output interface 205 by manipulating the input unit 206 or the like, executes in response the program stored in the ROM 202. Alternatively, the CPU 201 loads the program stored in the storage unit 208 to the random access memory (RAM) 203 and executes it.

As a result, the CPU 201 executes the processing shown in the aforementioned flowchart or the processing based on the configuration shown in the aforementioned block diagram. In addition, the CPU 201 outputs from the output unit 207, transmits through the communication unit 209, or records in the storage unit 208, the processing result, for example, using the input/output interface 205 as necessary.

In addition, the input unit 206 includes a keyboard, a mouse, a microphone, or the like. The output unit 207 includes a liquid crystal display (LCD), a loudspeaker, or the like.

Herein, the process executed by a computer based on a program is not necessarily carried out in time series in the sequence shown in the flowchart. Instead, the process executed by a computer based on a program may include other processes carried out in parallel or individually (for example, parallel processing or the processing using an object).

In addition, the program may be processed by a single computer (processor) or a plurality of computers in a distributed manner. Furthermore, the program may be executed by transmitting it to a remote computer.

The present application contains subject matter related to that disclosed in Japanese Priority Patent Application JP 2010-061173 filed in the Japan Patent Office on Mar. 17, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
determining means for determining, based on parallax of a 3D main image including a left-eye main image and a right-eye main image, parallax of a sub-image overlapped with the 3D main image and determining a zoom-in/out ratio of the sub-image based on parallax of the corresponding sub-image;
magnification/reduction processing means for magnifying or reducing the sub-image depending on the zoom-in/out ratio;
creating means for creating a left-eye sub-image and a right-eye sub-image by shifting the sub-image in left and right directions based on the parallax of the sub-image; and
synthesizing means for synthesizing, for each eye, the left-eye main image and the right-eye main image with the left-eye sub-image and the right-eye sub-image created by magnifying/reducing and shifting the sub-image in left and right directions.

2. The image processing apparatus according to claim 1, further comprising detection means for detecting parallax of the 3D main image.

3. The image processing apparatus according to claim 1, wherein the determining means determines the parallax of the sub-image based on the parallax of the 3D main image and a position of the sub-image on a screen.

4. The image processing apparatus according to claim 3, wherein a plurality of the sub-images are provided, and wherein
the determining means determines parallax of each sub-image based on the parallax of the 3D main image and positions of each sub-image on a screen and determines the zoom-in/out ratio of each sub-image based on the parallax of each sub-image,
the magnification/reduction processing means magnifies or reduces each sub-image based on the zoom-in/out ratio of the corresponding sub-image, and
the creating means creates a left-eye sub-image and a right-eye sub-image for each sub-image by shifting the sub-image in left and right directions based on the parallax of the corresponding sub-image.

5. The image processing apparatus according to claim 1, wherein the sub-image is a subtitle.

6. A method of processing an image using an image processing apparatus, the method comprising steps of:
determining, based on parallax of a 3D main image including a left-eye main image and a right-eye main image, parallax of a sub-image overlapped with the 3D main image and determining a zoom-in/out ratio of the sub-image based on parallax of the corresponding sub-image;
magnifying or reducing the sub-image depending on the zoom-in/out ratio;
creating a left-eye sub-image and a right-eye sub-image by shifting the sub-image in left and right directions based on the parallax of the sub-image; and
synthesizing, for each eye, the left-eye main image and the right-eye main image with the left-eye sub-image and the right-eye sub-image created by magnifying/reducing and shifting the sub-image in left and right directions.

7. A program for executing, on a computer, processing including steps of:
determining, based on parallax of a 3D main image including a left-eye main image and a right-eye main image, parallax of a sub-image overlapped with the 3D main image and determining a zoom-in/out ratio of the sub-image based on parallax of the corresponding sub-image;
magnifying or reducing the sub-image depending on the zoom-in/out ratio;
creating a left-eye sub-image and a right-eye sub-image by shifting the sub-image in left and right directions based on the parallax of the sub-image; and
synthesizing, for each eye, the left-eye main image and the right-eye main image with the left-eye sub-image and the right-eye sub-image created by magnifying/reducing and shifting the sub-image in left and right directions.

8. An image processing apparatus comprising:
a determining unit that determines, based on parallax of a 3D main image including a left-eye main image and a right-eye main image, parallax of a sub-image overlapped with the 3D main image and determines a zoom-in/out ratio of the sub-image based on parallax of the corresponding sub-image;
a magnification/reduction processing unit that magnifies or reduces the sub-image depending on the zoom-in/out ratio;
a creating unit that creates a left-eye sub-image and a right-eye sub-image by shifting the sub-image in left and right directions based on the parallax of the sub-image; and
a synthesizing unit that synthesizes, for each eye, the left-eye main image and the right-eye main image with the left-eye sub-image and the right-eye sub-image created by magnifying/reducing and shifting the sub-image in left and right directions.
